(19) United States
(12) Patent Application Publication
(10) Pub. No.: US 2025/0196350 A1
(43) Pub. Date: Jun. 19, 2025

(54) CONTROL DEVICE, CONTROL METHOD, PROGRAM, AND MOBILE BODY

(71) Applicant: SONY GROUP CORPORATION, TOKYO (JP)

(72) Inventors: HISAKA HIGA, TOKYO (JP); HIROSHI MIYAGAWA, TOKYO (JP)

(21) Appl. No.: 18/835,131

(22) PCT Filed: Dec. 22, 2022
(86) PCT No.: PCT/JP2022/047283

§ 371 Date: Aug. 1, 2024

(30) Foreign Application Priority Data
Feb. 10, 2022 (JP) 2022-019220

(51) Int. Cl. B25J 9/16; B25J 5/00; B25J 9/00

(52) U.S. Cl. CPC B25J 9/1666; B25J 5/007; B25J 9/0081; B25J 9/162; B25J 9/1633; B25J 9/1676

(57) ABSTRACT

To enable more intuitive operation of both a moving mechanism and a robot arm included in a mobile body.

A control device including a mode determination unit that determines a control mode of a mobile body including a moving mechanism and an articulated arm portion on the basis of a position of a distal end of the articulated arm portion of the mobile body, in which the moving mechanism and the articulated arm portion are controlled in a different manner for each control mode on the basis of the position of the distal end of the articulated arm portion or an external force applied to the distal end.

### TECHNICAL FIELD

The present disclosure relates to a control device, a control method, a program, and a mobile body.

### BACKGROUND ART

In recent years, controlling an action of a robot arm using direct teaching has been studied. The direct teaching is a method in which a user directly moves the robot arm by his/her hand to teach an action of the robot arm to the robot, and the robot is caused to reproduce the taught action.

Meanwhile, a movable manipulator (so-called mobile manipulator) including a robot arm and a moving mechanism has been developed (for example, Patent Document 1 below). The mobile manipulator can perform work more flexibly than a fixedly installed manipulator, and thus is expected to be used in a wider field.

### CITATION LIST

### Patent Document

Patent Document 1: Japanese Patent Application Laid-Open No. 2000-288967

### SUMMARY OF THE INVENTION

### Problems to be Solved by the Invention

In a case where the direct teaching is performed on the mobile manipulator, there is a possibility that, in the mobile manipulator, moving the robot arm causes the moving mechanism to move unintentionally.

For example, Patent Document 1 discloses that whether to manually operate a robot arm of a mobile robot or to manually operate a cart is selected by a switch. However, it is complicated to operate the switch each time the target of the manual operation is switched, which reduces the operation efficiency of the mobile robot.

Therefore, a mobile body in which both a moving mechanism and a robot arm can be more intuitively operated has been required.

### Solutions to Problems

According to the present disclosure, there is provided a control device including a mode determination unit that determines a control mode of a mobile body including a moving mechanism and an articulated arm portion on the basis of a position of a distal end of the articulated arm portion of the mobile body, in which the moving mechanism and the articulated arm portion are controlled in a different manner for each control mode on the basis of the position of the distal end of the articulated arm portion or an external force applied to the distal end.

Furthermore, according to the present disclosure, there is provided a control method including determining, by an arithmetic processing device, a control mode of a mobile body including a moving mechanism and an articulated arm portion on the basis of a position of a distal end of the articulated arm portion of the mobile body, in which the moving mechanism and the articulated arm portion are controlled in a different manner for each control mode on the basis of the position of the distal end of the articulated arm portion or an external force applied to the distal end.

Furthermore, according to the present disclosure, there is provided a program for causing a computer to function as a mode determination unit that determines a control mode of a mobile body including a moving mechanism and an articulated arm portion on the basis of a position of a distal end of the articulated arm portion of the mobile body, in which the moving mechanism and the articulated arm portion are controlled in a different manner for each control mode on the basis of the position of the distal end of the articulated arm portion or an external force applied to the distal end.

Moreover, according to the present disclosure, there is provided a mobile body including: a moving mechanism; an articulated arm portion attached to the moving mechanism; and a mode determination unit that determines a control mode of the moving mechanism and the articulated arm portion on the basis of a position of a distal end of the articulated arm portion, in which the moving mechanism and the articulated arm portion are controlled in a different manner for each control mode on the basis of the position of the distal end of the articulated arm portion or an external force applied to the distal end.

### BRIEF DESCRIPTION OF DRAWINGS

FIG. 1 is a schematic diagram illustrating a configuration of a mobile body to which the technology according to the present disclosure is applied.

FIG. 2 is a block diagram illustrating a functional configuration of a control unit of the mobile body illustrated in FIG. 1.

FIG. 3 is a schematic diagram illustrating an expression format of the position and orientation of the mobile body.

FIG. 4 is a flowchart illustrating an example of a specific flow of teaching.

FIG. 5 is a schematic diagram for describing an example of a three-dimensional shape of a manipulation region.

FIG. 6 is a schematic diagram for describing an example of the three-dimensional shape of the manipulation region.

FIG. 7 is a schematic diagram for describing an example of the three-dimensional shape of the manipulation region.

FIG. 8 is a schematic diagram for describing an example of a setting range of a movement control range.

FIG. 9 is a table data diagram illustrating patterns of control mode switching by a teaching control unit.

FIG. 10 is a table data diagram illustrating an example of teaching data of an arm portion.

FIG. 11 is a table data diagram illustrating an example of teaching data of a moving portion.

FIG. 12 is a flowchart illustrating an example of a specific flow of a playback.

FIG. 13 is a schematic diagram illustrating a specific example of teaching by a user directly operating the mobile body.

FIG. 14 is an explanatory diagram for describing a first modification of the mobile body.

### MODE FOR CARRYING OUT THE INVENTION

Hereinafter, a preferred embodiment of the present disclosure will be described in detail with reference to the accompanying drawings. Note that, in the present specification and the drawings, components having substantially the same functional configuration are denoted by the same reference numerals to avoid the description from being redundant.

Note that the description will be given in the following order.
1. Outline of mobile body
2. Configuration of control unit
3. Action examples
4. Specific example
5. Modifications

### 1. Outline of Mobile Body

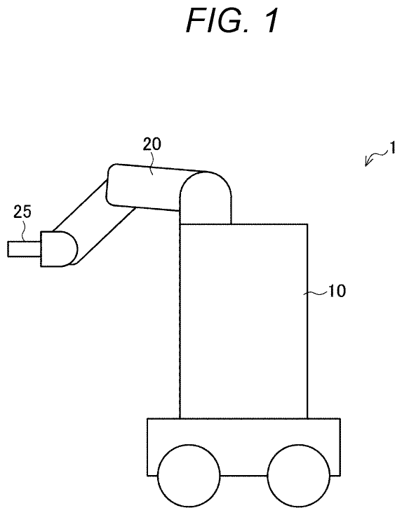

First, a mobile body to which the technology according to the present disclosure is applied will be described with reference to FIG. 1. FIG. 1 is a schematic diagram illustrating a configuration of a mobile body 1 to which the technology according to the present disclosure is applied.

As illustrated in FIG. 1, the mobile body 1 includes a moving portion 10, an arm portion 20, and an end effector portion 25.

The moving portion 10 includes a moving mechanism and a vehicle body to which the moving mechanism is attached. The moving portion 10 can move the mobile body 1 along a traveling surface by driving the moving mechanism. The moving mechanism may be any moving mechanism such as, for example, two or more wheels, two or more legs, a crawler, an air cushion, or a rotary blade. For example, the moving portion 10 may include a moving mechanism having four wheels in which rear wheels serve as drive wheels.

The arm portion 20 is an articulated robot arm including a plurality of links and a plurality of joints connecting the plurality of links to each other. The arm portion 20 is attached to, for example, an upper portion of the vehicle body of the moving portion 10. Note that, in the following description, in the arm portion 20, a side attached to the vehicle body of the moving portion 10 is referred to as a rear end side of the arm portion 20, and a side opposite to the rear end side is referred to as a distal end side of the arm portion 20. Note that the arm portion 20 is a specific example of an articulated arm portion in the present disclosure.

The end effector portion 25 is a device that is attached to the distal end side of the arm portion 20 and acts on an object existing in the surrounding environment. The end effector portion 25 may be, for example, a hand having a plurality of fingers, a gripper having a plurality of claws, a suction hand using air or a magnetic force, hooks having various shapes, or the like.

The mobile body 1 is taught an action by a user directly operating the arm portion 20. Specifically, the mobile body 1 stores, in time series, information regarding the position and orientation of the distal end of the arm portion 20 and information regarding the position and velocity of the moving portion 10 at the time of teaching. As a result, the mobile body 1 can reproduce (also referred to as playback) the taught action by operating the moving portion 10 and the arm portion 20 on the basis of the time-series data stored at the time of teaching.

Here, the action taught by the user to the mobile body 1 includes an action for moving the moving portion 10 and an action for manipulating an object by the arm portion 20. In the technology according to the present disclosure, the mobile body 1 at the time of teaching is controlled in different manners in different control modes of a movement mode and a manipulation mode, so that the user can more intuitively teach the mobile body 1.

The manipulation mode is a mode for teaching work by the arm portion 20. Specifically, in the manipulation mode, the arm portion 20 is controlled to move in a direction of an applied force in a case where the user operates the arm portion 20, and is controlled to stand still on the spot in a case where the user releases his/her hold on the arm portion 20. Meanwhile, the moving portion 10 is controlled so as not to move while the user operates the arm portion 20.

Furthermore, in the manipulation mode, the end effector portion 25 at the distal end of the arm portion 20 is also taught at the same time. For example, the end effector portion 25 may be taught by the user pressing an operation button or the like attached to the end effector portion 25 or directly operating the end effector portion 25.

The movement mode is a mode for teaching a moving route of the moving portion 10 or a work position of the moving portion 10. Specifically, in the movement mode, the moving portion 10 is controlled to move in a direction corresponding to the operation on the arm portion 20 in a case where the user operates the arm portion 20, and is controlled to stop on the spot in a case where the user releases his/her hold on the arm portion 20. Meanwhile, the arm portion 20 is controlled to return to the position before being operated by the user in a case where the user releases his/her hold on the arm portion 20.

In the technology according to the present disclosure, switching between the manipulation mode and the movement mode on the basis of the position of the distal end of the arm portion 20 enables the user to more intuitively operate the mobile body 1.

For example, since the movable range of the arm portion 20 is limited to the periphery of the mobile body 1, the mobile body 1 itself is required to move in a case where work is performed beyond the movable range of the arm portion 20. Therefore, in a case where the arm portion 20 is operated to exceed the manipulation region set to the periphery of the mobile body 1 during the manipulation mode, the control mode is switched to the movement mode.

On the other hand, in the movement mode, an operation on the arm portion 20 is handled as an instruction to move the moving portion 10. Therefore, an operation of the arm portion 20 in a direction in which the moving portion 10 can move leads to movement of the moving portion 10. Therefore, for switching from the movement mode to the manipulation mode, an operation of the arm portion 20 in the vertical direction, which is not used for an instruction to move the moving portion 10, is used. Specifically, in a case where the distal end of the arm portion 20 is operated to exceed a threshold in the vertical direction during the movement mode, the control mode is switched to the manipulation mode. According to this switching, the mobile body 1 can prevent the moving portion 10 from unintentionally moving at the time of operation of switching from the movement mode to the manipulation mode.

Note that the mobile body 1 may be provided with a device for transmitting switching of the control mode to the user. For example, the arm portion 20 may be provided with a light emitting unit including a light emitting device such as a light emitting diode (LED). The light emitting unit can transmit switching of the control mode to the user by emitting light with a different light emission pattern or a different light emission color for each control mode. Furthermore, the arm portion 20 may be provided with a vibration unit that transmits switching of the control mode to the user in different vibration patterns.

In a case where the user finishes teaching to the mobile body 1 using the manipulation mode and the movement mode, the mobile body 1 ends the action for teaching, and labels (names) and stores teaching data for reproducing the teaching. The mobile body 1 reproduces the stored teaching data, and thus can reproduce the taught action after moving to the position at the start of teaching.

Hereinafter, a control unit of the mobile body 1 that enables the above control will be described in more detail.

### 2. Configuration of Control Unit

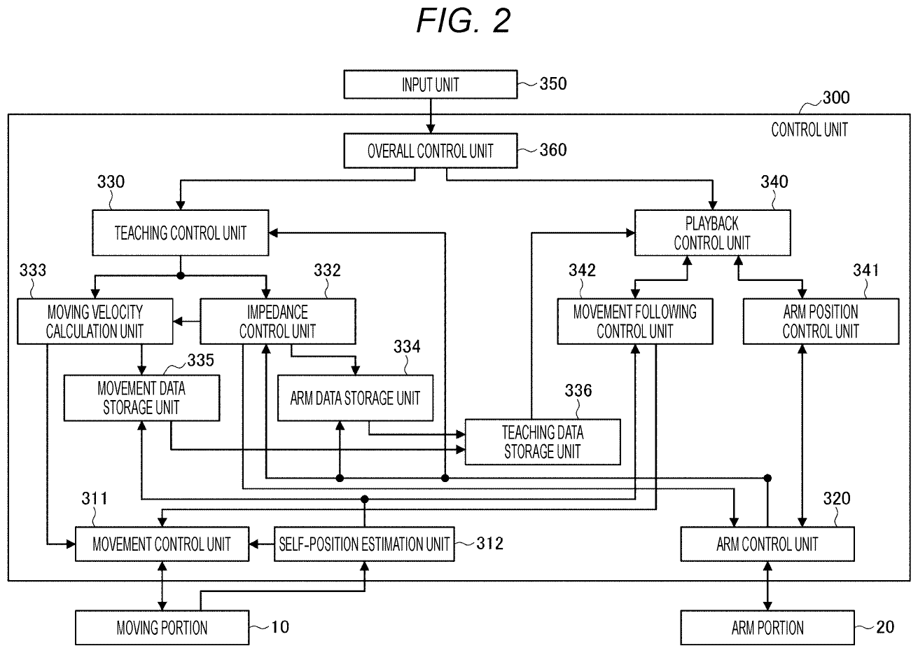

Next, a configuration of a control unit 300 that controls an action of the mobile body 1 will be described with reference to FIG. 2. FIG. 2 is a block diagram illustrating a functional configuration of the control unit 300 of the mobile body 1.

As illustrated in FIG. 2, the control unit 300 includes an overall control unit 360 to which an operation by a user is input via an input unit 350, a movement control unit 311 and a self-position estimation unit 312 related to control of the moving portion 10, and an arm control unit 320 related to control of the arm portion 20.

The control unit 300 includes a teaching control unit 330, an impedance control unit 332, a moving velocity calculation unit 333, an arm data storage unit 334, a movement data storage unit 335, and a teaching data storage unit 336 as configurations related to teaching. Note that the teaching control unit 330 is a specific example of a mode determination unit in the present disclosure.

Moreover, the control unit 300 includes a playback control unit 340, an arm position control unit 341, and a movement following control unit 342 as configurations related to playback.

Note that each function of the control unit 300 can be implemented by cooperation of software and hardware including a central processing unit (CPU), a read only memory (ROM), and a random access memory (RAM). Furthermore, it is also possible to create a program for causing hardware built in a computer to exhibit functions equivalent to those of the control unit 300, and it is also possible to provide a computer-readable recording medium in which the program is recorded.

The input unit 350 is a user interface that receives an operation from the user. Specifically, the input unit 350 receives an operation of starting or stopping teaching to the mobile body 1 from the user, and receives an operation of starting or stopping reproduction (playback) of a taught action. The input unit 350 may include, for example, a user interface such as a touch panel, a button, a switch, or a lever.

The overall control unit 360 controls each of the teaching control unit 330 and the playback control unit 340 on the basis of an operation input to the input unit 350. Specifically, in a case where an instruction to start or stop teaching is given, the overall control unit 360 may instruct the teaching control unit 330 to start or stop the teaching. Furthermore, in a case where an instruction to play back a taught action is given, the overall control unit 360 may instruct the playback control unit 340 to start or stop the playback.

However, the control unit 300 may be configured such that an operation input to the input unit 350 is directly input to the teaching control unit 330 and the playback control unit 340 without the overall control unit 360.

The teaching control unit 330 determines the control mode of the mobile body 1 and controls the entire action at the time of teaching. Specifically, the teaching control unit 330 may determine whether the control mode is the movement mode or the manipulation mode on the basis of the position of the distal end of the arm portion 20 acquired from the arm control unit 320. Moreover, the teaching control unit 330 may transmit the determined control mode to the impedance control unit 332 and the moving velocity calculation unit 333.

The control modes define control of the moving portion 10 and the arm portion 20 in response to an operation by the user on the distal end of the arm portion 20 in different manners. For example, in the movement mode, the movement of the moving portion 10 is controlled on the basis of an operation by the user on the distal end of the arm portion 20. In the manipulation mode, the position and orientation of the distal end of the arm portion 20 are controlled on the basis of an operation by the user on the distal end of the arm portion 20. The teaching control unit 330 switches the control mode to either the movement mode or the manipulation mode on the basis of the position of the distal end of the arm portion 20, thereby enabling the user to more intuitively switch the control manner of the moving portion 10 and the arm portion 20. According to this switching, the teaching control unit 330 can prevent the moving portion 10 from moving or not moving against the user's intention.

The impedance control unit 332 acquires information such as an angle or an angular velocity of each joint of the arm portion 20 from the arm control unit 320 and performs calculation using kinematics or dynamics to derive a torque of each joint of the arm portion 20 having a desired mechanical impedance characteristic. Furthermore, the impedance control unit 332 can control the orientation of the arm portion 20 by outputting the derived torque to the arm control unit 320.

Specifically, the mechanical impedance of the arm portion 20 can be expressed by Formula 1 below using a virtual damper and spring.

$$[ Math . 1 ]$$

$${M}_{d} \ddot{x} + {D}_{d} ( \dot{x} - {\dot{x}}_{d} ) + {K}_{1} ( x - {x}_{d} ) = F \qquad ( Formula 1 )$$

In Formula 1, F is a 6-dimensional column vector expressing an external force applied to the distal end of the arm portion 20. x is a 6-dimensional column vector indicating the current position of the distal end of the arm portion 20, and x_{d} is a 6-dimensional column vector indicating a target position of the distal end of the arm portion 20. M_{d}, D_{d}, and K_{d} are an inertia matrix, a damping coefficient matrix, and a rigidity matrix that are 6×6 matrices and satisfy a desired mechanical impedance, respectively. In Formula 1, the second term on the left side expresses the virtual damper, and the third term on the left side expresses the virtual spring.

The impedance control unit 332 can control the terms of the virtual damper and spring of Formula 1 described above so as to obtain a mechanical impedance characteristic suitable for the control mode determined by the teaching control unit 330.

For example, in the manipulation mode, the impedance control unit 332 may invalidate the term of the virtual spring and validate only the term of the virtual damper to derive a torque that makes the distal end of the arm portion 20 heavy according to the velocity of the distal end of the arm portion 20. On the other hand, in the movement mode, the impedance control unit 332 may validate the term of the virtual spring in a direction in which the moving portion 10 can move to derive a torque in which the arm portion 20 naturally returns to a reference position in a case where the external force is not applied to the distal end of the arm portion 20.

Furthermore, in the movement mode, as an example, the impedance control unit 332 may deliver a displacement amount (x−x_{d}) between the position of the distal end of the arm portion 20 and the position to the moving velocity calculation unit 333 as an amount of operation on the moving portion 10. As another example, the impedance control unit 332 may deliver an external force F applied to the distal end of the arm portion 20 to the moving velocity calculation unit 333 as an amount of operation on the moving portion 10. On the other hand, in the manipulation, the impedance control unit 332 may deliver 0 to the moving velocity calculation unit 333 as an amount of operation on the moving portion 10.

The moving velocity calculation unit 333 derives a target velocity of the moving portion 10 (that is, the velocity in the front-rear direction and the angular velocity in the turning direction). Specifically, in the movement mode, the moving velocity calculation unit 333 derives the target velocity of the moving portion 10 (that is, the velocity in the front-rear direction and the angular velocity in the turning direction) on the basis of the amount of operation on the moving portion 10 received from the impedance control unit 332. Moreover, the moving velocity calculation unit 333 can control the position and velocity of the moving portion 10 by outputting the derived target velocity to the movement control unit 311. On the other hand, in the manipulation mode, the moving velocity calculation unit 333 derives the target velocity of the moving portion 10 (that is, all velocities and angular velocities) as 0 and outputs 0 to the movement control unit 311.

The self-position estimation unit 312 estimates the position and orientation of the mobile body 1 using information regarding driving of the moving mechanism of the moving portion 10 or using information regarding the surrounding environment acquired from an inertial measurement unit (IMU) or a distance measurement sensor.

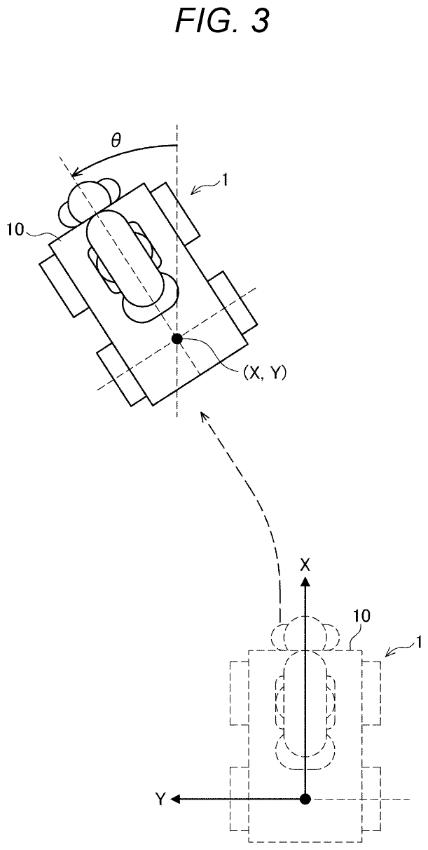

The position and orientation of the mobile body 1 can be expressed, for example, in a format as illustrated in FIG. 3. FIG. 3 is a schematic diagram illustrating an expression format of the position and orientation of the mobile body 1.

As illustrated in FIG. 3, the position of the mobile body 1 may be expressed in an XY coordinate system with the position of the mobile body 1 at the time of activation as an origin. For example, the position of the mobile body 1 may be expressed by the center-of-gravity position of the mobile body 1 at the time of activation, may be expressed by the center position of the drive wheels (rear wheels in the drawing), or may be expressed by the position of any feature point such as a corner when the moving portion 10 is viewed in plan view from above. Furthermore, the orientation of the mobile body 1 may be expressed by a rotation angle in which the orientation of the moving portion 10 at the time of activation is set as 0 degrees and the counterclockwise direction when the moving portion 10 is viewed in plan view from above is set as positive.

The arm data storage unit 334 stores information regarding the angle of each joint of the arm portion 20 acquired from the arm control unit 320 together with time for playback to be described later in parallel with the calculation by the impedance control unit 332. Note that, in a case where the end effector portion 25 such as a hand is provided at the distal end of the arm portion 20, the arm data storage unit 334 may also store information regarding opening and closing of the hand of the end effector portion 25 in addition to the information regarding the angle of each joint of the arm portion 20 together with time. The information stored in the arm data storage unit 334 is labeled and stored in the teaching data storage unit 336 in a case where the overall control unit 360 gives an instruction to end the teaching.

The movement data storage unit 335 stores the self-position estimated by the self-position estimation unit 312 and the moving velocity derived by the moving velocity calculation unit 333 together with time for playback to be described later in parallel with the calculation by the moving velocity calculation unit 333. The information stored in the movement data storage unit 335 is labeled and stored in the teaching data storage unit 336 in a case where the overall control unit 360 gives an instruction to end the teaching.

The playback control unit 340 reads the teaching data of the arm portion 20 and the teaching data of the moving portion 10 from the teaching data storage unit 336, and delivers the read data to the arm position control unit 341 and the movement following control unit 342, respectively.

The arm position control unit 341 outputs a command to operate each joint of the arm portion 20 in position control to the arm control unit 320 on the basis of a target angle of each joint of the arm portion 20 in the teaching data.

The movement following control unit 342 performs control to cause the moving portion 10 to follow the target position from the self-position on the basis of the target position and the target velocity of the moving portion 10 in the teaching data and the self-position of the moving portion 10 estimated by the self-position estimation unit 312. Specifically, a velocity vₓ of the moving portion 10 and an angular velocity ω_{z} for turning are controlled according to Formulas 2 below. The movement following control unit 342 can control the position of the moving portion 10 by outputting the derived velocity and angular velocity to the movement control unit 311.

$$[ Math . 2 ]$$

$${v}_{x} = {v}_{x , des} - \{ {K}_{p , x} Δ x + {K}_{d , x} ( Δ x - Δ {x}^{′} ) \} \qquad ( Formula 2 )$$

$${ω}_{z} = {ω}_{z , des} - {ν}_{x} \{ {K}_{p , γ} Δ y + {K}_{d , y} ( Δ y - Δ {y}^{′} ) \} - \{ {K}_{p , yaw} Δ θ + {K}_{d , yaw} ( Δ θ - Δ {θ}^{′} ) \}$$

In each of Formulas 2, v_{x,des} and ω_{z,des} in the first term on the right side are the target velocity and the target angular velocity, respectively, and are used as feedforward terms. Each of the second and subsequent terms on the right side of each of Formulas 2 is a feedback term, and Δx, Δy, and Δθ are a difference in the x direction, a difference in the y direction, and a difference in the rotation angle of the orientation from the self-position to the target position, respectively. Furthermore, Δx′, Δy′, and Δθ′ are a difference in the x direction, a difference in the y direction, and a difference in the rotation angle of the orientation in the previous step, respectively. K_{p,x}, K_{p,y}, and K_{p,yaw} are gains of positions in the respective directions, and K_{a,x}, K_{a,y}, and K_{a,yaw} are gains of velocities expressed by differences in positions in the respective directions.

The movement control unit 311 receives the velocity and the angular velocity of the moving portion 10 derived by the moving velocity calculation unit 333 or the movement following control unit 342, and drives the moving mechanism of the moving portion 10 so as to obtain the received velocity and angular velocity.

The arm control unit 320 receives information from the impedance control unit 332 or the arm position control unit 341, and drives an actuator of each joint of the arm portion 20 on the basis of the received information. The arm control unit 320 may acquire information regarding an angle, angular velocity, and torque of each joint of the arm portion 20 in order to control the arm portion 20. The arm control unit 320 may estimate an external force to the distal end of the arm portion 20 viewed from the rear end of the arm portion 20 on the basis of the information regarding the torque of each joint. Furthermore, in a case where the end effector portion 25 such as a hand is provided at the distal end of the arm portion 20, the arm control unit 320 may further control opening and closing of the end effector portion 25 such as a hand.

The angle of each joint of the arm portion 20 can be measured by, for example, an encoder attached to the arm portion 20. Furthermore, the external force applied to the distal end of the arm portion 20 can be measured by a torque sensor attached to each joint of the arm portion 20 or by a force sensor in translation three-axis directions provided at the distal end of the arm portion 20. Note that, even for an arm portion 20 having a different shaft arrangement, such as a SCARA robot or a robot arm having a linear motion joint shaft, attaching a force sensor to the distal end of the arm portion 20 makes it possible to similarly implement teaching to the moving portion 10 and the arm portion 20.

### 3. Action Examples

### (Specific Flow of Teaching)

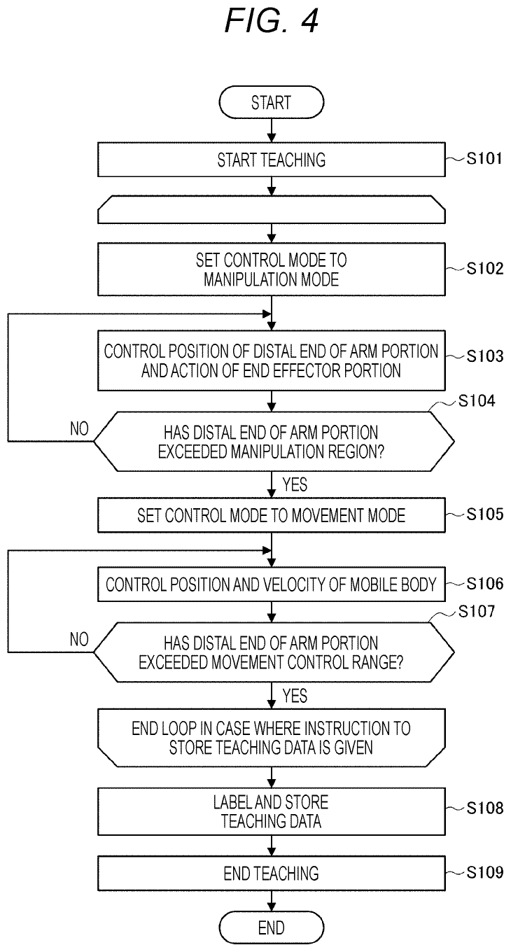

The control unit 300 can execute teaching in a flow illustrated in FIG. 4, for example. FIG. 4 is a flowchart illustrating an example of a specific flow of teaching by the control unit 300.

Teaching is started when an instruction to start teaching is given from the overall control unit 360 (S101). First, the teaching control unit 330 sets the manipulation mode as a default control mode and transmits the manipulation mode to the impedance control unit 332 and the moving velocity calculation unit 333 (S102).

Immediately after the start of the teaching, the mobile body 1 stands still on the spot until a user starts an operation. That is, the moving portion 10 stops on the spot because the moving mechanism is not driven. Furthermore, the arm portion 20 maintains the orientation and stands still because the target position is set to the position at the time of activation in the term of the virtual spring and the target velocity is set to 0 in the term of the virtual damper.

In a case where the user applies an external force to the distal end of the arm portion 20 for teaching, the impedance control unit 332 derives a torque of each joint of the arm portion 20 using impedance parameters for the manipulation mode. Specifically, the impedance control unit 332 invalidates the term of the virtual spring by setting the third term (K_{d}(x−x_{d})) on the left side of Formula 1 described above to a zero matrix, and validates only the term of the virtual damper. According to this operation, the impedance control unit 332 can derive the torque of each joint to make the distal end of the arm portion 20 heavy according to the velocity of the distal end of the arm portion 20.

Subsequently, the impedance control unit 332 outputs an instruction to output the derived torque of each joint to the arm control unit 320 (S103). The arm control unit 320 operates the arm portion 20 using the torque of each joint indicated by the impedance control unit 332 as a command value. According to this operation, in the manipulation mode, the arm portion 20 can be operated by the user in a state where the virtual damper is given so as to be easily positioned, and can stand still on the spot in a case where the user releases his/her hold.

Meanwhile, in the manipulation mode, the moving velocity calculation unit 333 does not derive the velocity of the moving portion 10 and outputs an instruction that the velocity of the moving portion 10 is 0 to the movement control unit 311 instead. As a result, the movement control unit 311 instructs the moving portion 10 to set the velocity to 0, and thus the moving portion 10 continues to stop on the spot.

Here, the teaching control unit 330 acquires the position of the distal end of the arm portion 20 from the arm control unit 320 during the teaching, and determines whether or not the position of the distal end of the arm portion 20 exceeds the manipulation region (S104). In a case where the distal end of the arm portion 20 does not exceed the manipulation region (S104/No), the teaching control unit 330 determines that the control mode is the manipulation mode. As a result, the teaching control unit 330 transmits an instruction to continue to act in the manipulation mode to the impedance control unit 332 and the moving velocity calculation unit 333.

On the other hand, in a case where the position of the distal end of the arm portion 20 exceeds the manipulation region by the user operating the arm portion 20 (S104/Yes), the teaching control unit 330 determines that the control mode is the movement mode. As a result, the teaching control unit 330 transmits information indicating that the control mode has been switched to the movement mode to the impedance control unit 332 and the moving velocity calculation unit 333 (S105).

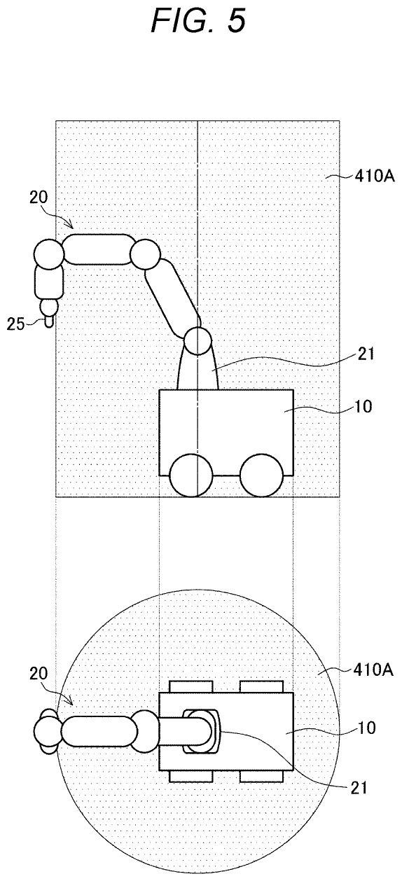

As illustrated in FIGS. 5 to 7, the manipulation region may be set to a rotating body shape having a first joint shaft 21, which is attached to the moving portion 10 of the arm portion 20 and is first from the rear end side, as a central axis. FIGS. 5 to 7 are schematic diagrams for describing examples of a three-dimensional shape of the manipulation region.

For example, as illustrated in FIG. 5, a manipulation region 410A may be set to a cylindrical shape having the first joint shaft 21, which is attached to the moving portion 10 of the arm portion 20 and is first from the rear end side, as the central axis.

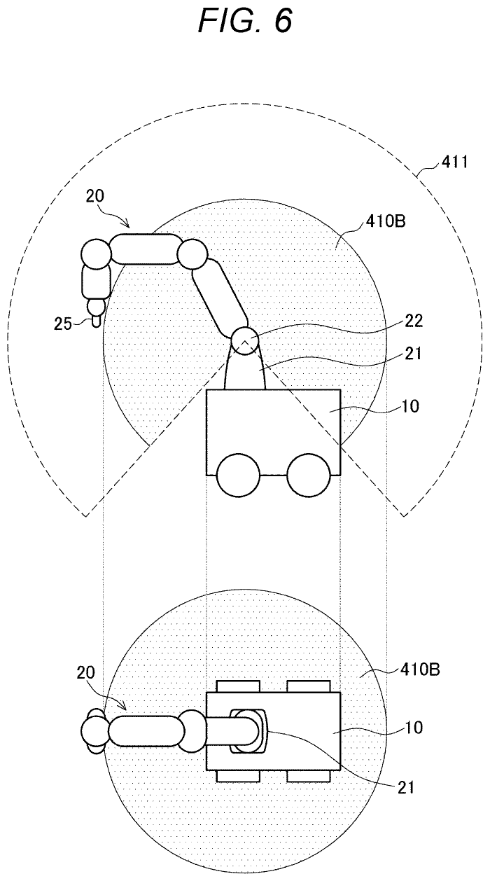

Furthermore, as illustrated in FIG. 6, a manipulation region 410B may be set to a spherical shape centered on the intersection of the first joint shaft 21, which is attached to the moving portion 10 of the arm portion 20 and is first from the rear end side, and a second joint shaft 22, which is second from the rear end side. In such a case, the manipulation region 410B is set to approximate an action range 411 of the arm portion 20, and thus it is possible to more smoothly switch between the manipulation mode and the movement mode. Furthermore, the manipulation region 410B may be set to a shape in which a margin is further provided for a shape in which the movable range of each joint is mapped to a work space from the forward kinematics of the arm portion 20, in order to correspond to the actual action range 411 of the arm portion 20 more closely.

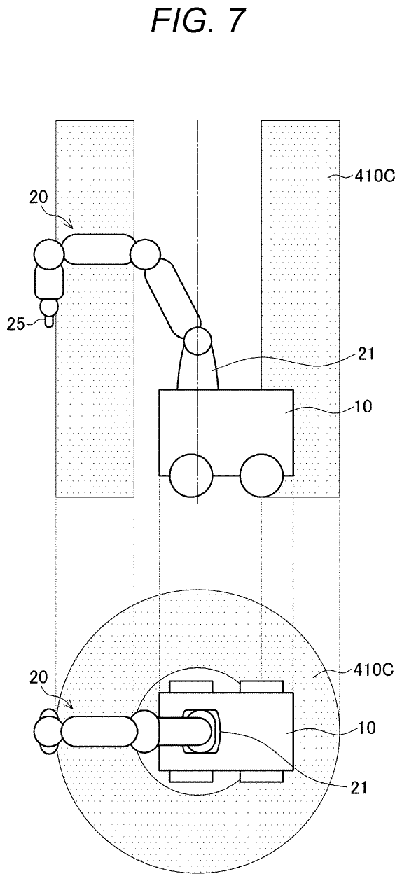

Furthermore, as illustrated in FIG. 7, a manipulation region 410C may be set to a hollow cylindrical shape having the first joint shaft 21, which is attached to the moving portion 10 of the arm portion 20 and is first from the rear end side, as a central axis. In the manipulation regions 410A and 410B illustrated in FIGS. 4 and 5, in a case where the control mode is switched to the movement mode in order to move the mobile body 1 backward, the arm portion 20 is once pulled out to the outside of the manipulation regions 410A and 410B and then pushed to move the mobile body 1 backward. However, this is not an intuitive operation for the user as an operation of the mobile body 1. Furthermore, in order to avoid self-collision, it is considered that the arm portion 20 is not frequently operated on the center side of the mobile body 1. Therefore, the manipulation region 410C may be set to a hollow cylindrical shape such that the control mode can be switched to the movement mode even by an operation of pushing the arm portion 20 toward the center side of the mobile body 1.

Moreover, the manipulation regions 410A, 410B, and 410C may be set as regions having a high degree of operability of the arm portion 20. According to this setting, the mobile body 1 can exclude the center side of the mobile body 1, which has a low degree of operability, from the manipulation regions 410A, 410B, and 410C.

In the movement mode, the impedance control unit 332 derives the torque of each joint of the arm portion 20 using impedance parameters for the movement mode. Specifically, the impedance control unit 332 sets K_{d} in Formula 1 described above in a direction in which the mobile body 1 is can move to a value larger than 0. Furthermore, the impedance control unit 332 stores the position of the distal end of the arm portion 20 when the control mode is switched to the movement mode (hereinafter, the position is defined as a reference position) as x_{d} of Formula 1 described above. According to this operation, the arm portion 20 is controlled to return to the above-described reference position when the user releases his/her hold.

Moreover, the impedance control unit 332 outputs an instruction to output the torque of each joint derived above to the arm control unit 320. The arm control unit 320 operates the arm portion 20 using the torque of each joint indicated by the impedance control unit 332 as a command value.

Meanwhile, in the movement mode, the moving velocity calculation unit 333 derives the velocity in the front-rear direction and the angular velocity in the turning direction of the moving portion 10 on the basis of the amount of operation on the moving portion 10 received from the impedance control unit 332. Specifically, the moving velocity calculation unit 333 derives the velocity and the angular velocity of the moving portion 10 on the basis of any value of a position deviation between the reference position and the position of the distal end of the arm portion 20 or an estimated external force applied to the arm portion 20, which is input as an amount of operation from the impedance control unit 332.

For example, the moving velocity calculation unit 333 can derive the velocity vₓ in the front-rear direction by using Formula 3 below.

$$[ Math . 3 ]$$

$${v}_{x} = \{ \begin{matrix}{K}_{t , f} {F}_{x} ( {K}_{t , f} < 0 ) & ( In a case where the input is an estimated external force ) \\ {K}_{t , s} {d}_{x} ( {K}_{t , s} > 0 ) & ( In a case where the input is a position deviation )\end{matrix} \qquad ( Formula 3 )$$

In Formula 3, Fₓ is an estimated external force in the forward direction of the moving portion 10 (for example, the X direction), and dx is a forward direction (for example, X direction) component of the position deviation of the moving portion 10. K_{t,f} and K_{t,s} are constants for adjusting the sensitivity of input.

In a case where the moving mechanism of the moving portion 10 is an opposing two-wheel type, the position of the distal end of the arm portion 20 on the traveling surface viewed from the center of the drive wheels is defined as (x_{ee,base}, y_{ee,base}). Assuming that the turning velocity of the moving portion 10 is proportional to the moment of the force around the Z axis of the moving portion 10, the moving velocity calculation unit 333 can derive the angular velocity ω_{z} for turning of the moving portion 10 by using Formula 4 below.

$$( Formula 4 )$$

$$w \text{?} = \{ \begin{matrix}{K}_{r , f} ( {x}_{ee , base} {F}_{y} - {y}_{ee , base} {F}_{x} ( K \text{?} < 0 ) & \begin{matrix}( In a case where the input is an \\ estimated external force )\end{matrix} \\ {K}_{r , s} ( {x}_{ee , base} {d}_{y} - {y}_{ee , base} {d}_{z} ( K \text{?} > 0 ) & ( In a case where the input is a position deviation )\end{matrix}$$

$$\text{?} \text{indicates text missing or illegible when filed}$$

In Formula 4, F_{y} is an estimated external force in the left-right direction (Y direction) of the moving portion 10, and d_{y} is a left-right direction (for example, Y direction) component of the position deviation of the moving portion 10. K_{r,f} and K_{r,s} are constants for adjusting the sensitivity of input in the turning direction, similarly to K_{t,f} and K_{t,s}.

Note that, even in a case where the moving mechanism of the moving portion 10 is a type other than the opposing two-wheel type, such as a crawler type, an omnidirectional moving type, or a legged moving type, the movement of the moving portion 10 can be similarly controlled. Specifically, the turning center, which is set to the center of the drive wheels in the above description, is set to the center of the moving portion 10 (for example, the center of gravity), and control is performed to satisfy the turning velocity derived by Formula 4, whereby it is possible to similarly control the movement of the moving portion 10.

Furthermore, the moving velocity calculation unit 333 outputs the derived velocity in the front-rear direction and the derived angular velocity in the turning direction to the movement control unit 311 (S106). The movement control unit 311 drives the moving mechanism of the moving portion 10 so as to implement the received velocity in the front-rear direction and the received angular velocity in the turning direction. As a result, in the movement mode, the mobile body 1 can move the moving portion 10 forward or backward or turn the moving portion 10 in the direction in which the user operates the arm portion 20.

Here, the teaching control unit 330 acquires the position of the distal end of the arm portion 20 from the arm control unit 320 during the teaching, and determines whether or not the position of the distal end of the arm portion 20 exceeds a movement control range (S107). In a case where the distal end of the arm portion 20 does not exceed the movement control range (S107/No), the teaching control unit 330 determines that the control mode is the movement mode. As a result, the teaching control unit 330 transmits an instruction to continue to act in the movement mode to the impedance control unit 332 and the moving velocity calculation unit 333.

On the other hand, in a case where the position of the distal end of the arm portion 20 exceeds the movement control range by the user operating the arm portion 20 (S107/Yes), the teaching control unit 330 determines that the control mode is the manipulation mode. As a result, the teaching control unit 330 transmits information indicating that the control mode has been switched to the manipulation mode to the impedance control unit 332 and the moving velocity calculation unit 333 (S102).

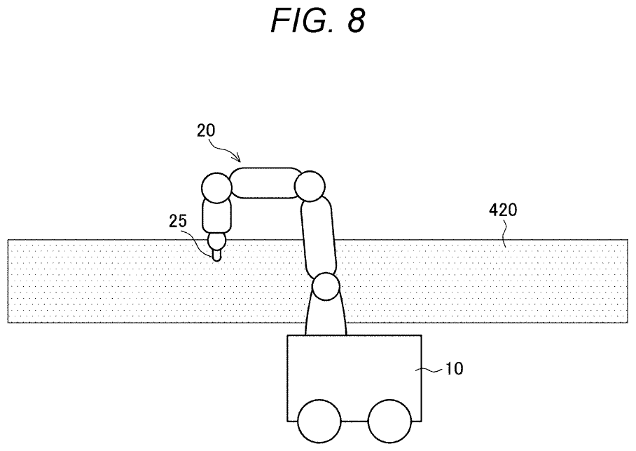

As illustrated in FIG. 8, the movement control range may be set to a band-shaped space parallel to the traveling surface. FIG. 8 is a schematic diagram for describing an example of a setting range of the movement control range.

As illustrated in FIG. 8, a movement control range 420 may be a band-shaped range in which upper and lower thresholds are set in the normal direction of the traveling surface. Furthermore, the upper and lower thresholds may be set above and below the position of the distal end of the arm portion 20 when the manipulation mode is switched to the movement mode (that is, the reference position). According to this setting, the arm portion 20 is operated in the vertical direction, which is not used for an instruction to move the moving portion 10, so that the mobile body 1 can be switched from the movement mode in which the mobile body 1 is moved to the manipulation mode in which the arm portion 20 is operated. Therefore, the user can smoothly switch between the movement mode and the manipulation mode only by operating the arm portion 20.

However, the teaching control unit 330 determines switching to the manipulation mode and switching to the movement mode using different conditions. Therefore, the position of the distal end of the arm portion 20 may meet both conditions for switching to the manipulation mode and for switching to the movement mode. For example, in a case where the control mode is switched to the movement mode by the arm portion 20 being pulled out forward of the mobile body 1, and the arm portion 20 is then further operated upward, there is a possibility that both the condition for switching from the manipulation mode to the movement mode and the condition for switching from the movement mode to the manipulation mode are satisfied.

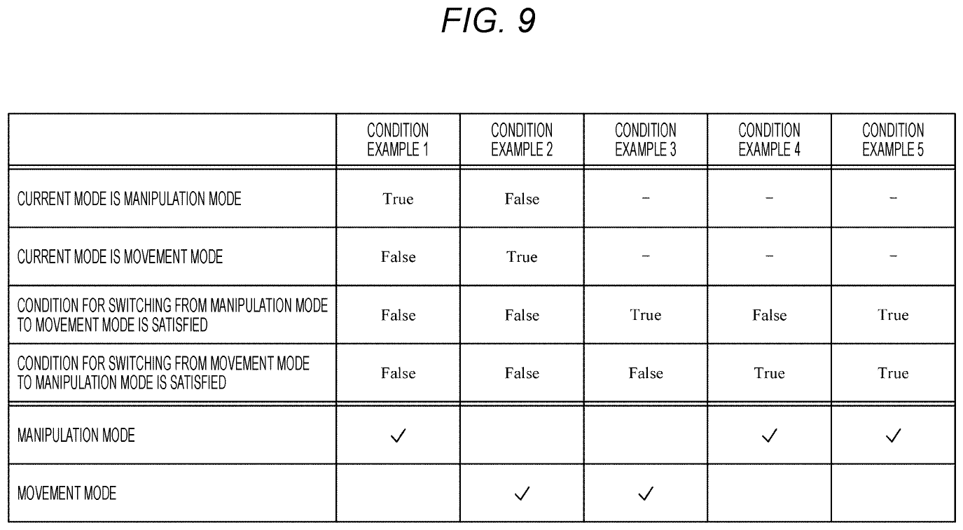

Therefore, the teaching control unit 330 may switch the control mode on the basis of a condition table illustrated in FIG. 9. FIG. 9 is a table data diagram illustrating patterns of control mode switching by the teaching control unit 330.

As illustrated in FIG. 9, in a case where the current control mode is the manipulation mode and none of the switching conditions of the control mode is satisfied, the teaching control unit 330 determines that the control mode is the manipulation mode (condition example 1). In a case where the current control mode is the movement mode and none of the switching conditions of the control mode is satisfied, the teaching control unit 330 determines that the control mode is the movement mode (condition example 2). Meanwhile, in a case where only the switching condition from the manipulation mode to the movement mode is satisfied, the teaching control unit 330 determines that the control mode is the movement mode (condition example 3). In a case where only the switching condition from the movement mode to the manipulation mode is satisfied, the teaching control unit 330 determines that the control mode is the manipulation mode (condition example 4).

Furthermore, in a case where both the switching condition from the manipulation mode to the movement mode and the switching condition from the movement mode to the manipulation mode are satisfied, the teaching control unit 330 determines that the control mode is the manipulation mode (condition example 5). This is because, comparing a case where the moving portion 10 unintentionally moves and a case where the arm portion 20 unintentionally moves, the case where the arm portion 20 unintentionally moves has higher safety for the user. Therefore, in the case illustrated in the condition example 5, the teaching control unit 330 determines the control mode as the manipulation mode with emphasis on safety for the user.

After the teaching by the user, in a case where an instruction to end the teaching is given via the input unit 350 (withdrawal from the loop), the overall control unit 360 instructs the teaching control unit 330 to store teaching data. As a result, the teaching data stored in the arm data storage unit 334 and the movement data storage unit 335 is labeled (named) and stored in the teaching data storage unit 336 (S108). After storing the teaching data, the overall control unit 360 ends the action of the teaching control unit 330, thereby also ending the action of the moving portion 10 and the arm portion 20 (S109).

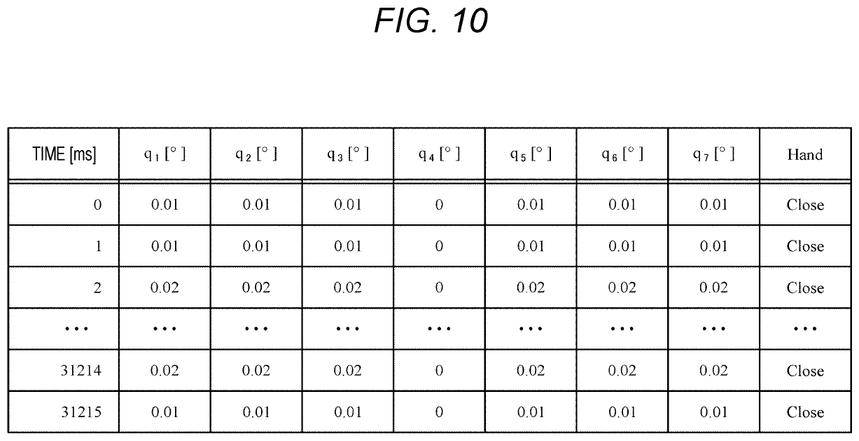

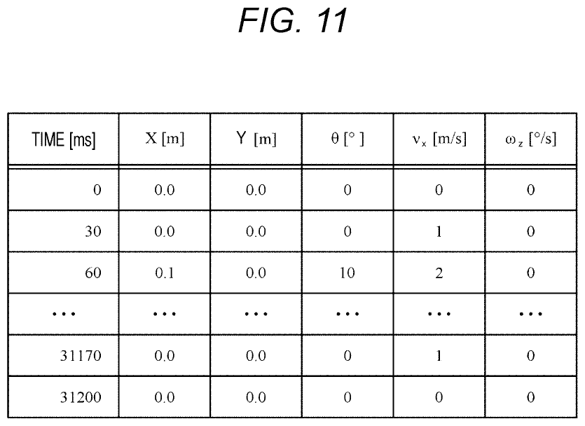

The teaching data stored in the teaching data storage unit 336 may be, for example, in a format illustrated in FIGS. 10 and 11. FIG. 10 is a table data diagram illustrating an example of teaching data of the arm portion 20. FIG. 11 is a table data diagram illustrating an example of teaching data of the moving portion 10.

As illustrated in FIG. 10, the teaching data of the arm portion 20 may be time-series data including time when data is acquired, the angle of each joint of the arm portion 20 (q₁ . . . q₇), and information regarding the end effector portion 25 (open/close information of the hand).

As illustrated in FIG. 11, the teaching data of the moving portion 10 may be time-series data including time when data is acquired, the self-position (X, Y) and orientation (θ) of the moving portion 10, the derived velocity (vₓ) in the front-rear direction, and the derived angular velocity (ω_{z}) in the turning direction.

In FIGS. 10 and 11, continuous time series data acquired at predetermined intervals is illustrated as teaching data, but the technology according to the present disclosure is not limited to the above examples. In order to reduce the volume of data, the teaching data storage unit 336 may store, as teaching data, only the data of the moving portion 10 and the arm portion 20 while the arm portion 20 is determined to be operated by the user.

Specifically, the arm data storage unit 334 and the movement data storage unit 335 may store only the teaching data in a period in which the distal end of the arm portion 20 is determined to be operated by the user from information regarding an estimated external force acquired from the arm control unit 320. Furthermore, the arm data storage unit 334 may omit the data related to the operation of the arm portion 20 during the movement mode from the teaching data by receiving information regarding the control mode from the impedance control unit 332.

### (Specific Flow of Playback)

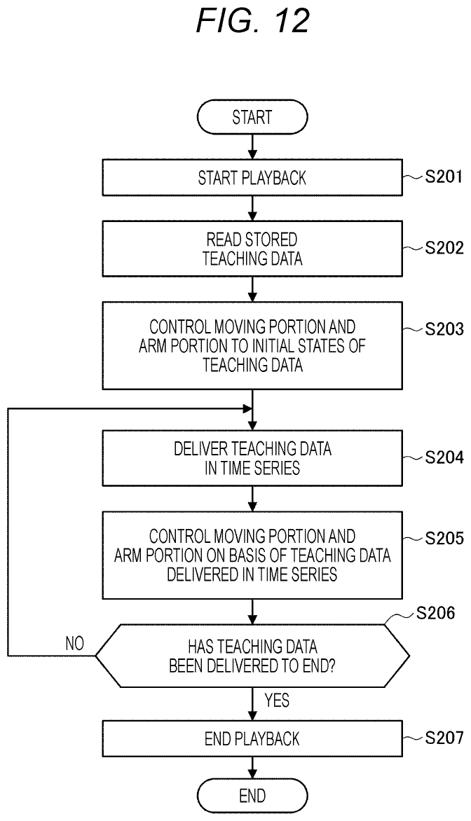

The control unit 300 can execute a playback in a flow illustrated in FIG. 12, for example. FIG. 12 is a flowchart illustrating an example of a specific flow of a playback by the control unit 300.

When an instruction to start a playback is given from the overall control unit 360, the playback for reproducing a taught action is started (S201). First, the playback control unit 340 reads teaching data of the arm portion 20 and the moving portion 10 to be played back from the teaching data storage unit 336 (S202). The playback control unit 340 delivers the first data (that is, the data indicating the initial state) in the read teaching data to each of the arm position control unit 341 and the movement following control unit 342.

In a case of receiving the first data in the teaching data, the arm position control unit 341 initializes the orientation of the arm portion 20 by instructing the arm control unit 320 on an action of the arm portion 20 to transition to an orientation corresponding to the first data (S203). Specifically, the arm position control unit 341 instructs the arm control unit 320 on a smooth action on a movement trajectory using a trajectory generation method based on sampling or the like, which considers an obstacle, or general trapezoidal velocity interpolation, thereby causing the orientation of the arm portion 20 to transition to the orientation corresponding to the first data. In a case where the orientation of the arm portion 20 substantially coincides with the orientation corresponding to the first data (an error falls within an allowable value), the arm position control unit 341 notifies the playback control unit 340 that the preparation of the arm portion 20 side has been completed.

In a case of receiving the first data in the teaching data, the movement following control unit 342 instructs the movement control unit 311 to move the moving portion 10 to transition to a position and velocity corresponding to the first data (S203). In a case where the position and velocity of the moving portion 10 substantially coincide with the position and velocity corresponding to the first data (an error is within an allowable value), the movement following control unit 342 notifies the playback control unit 340 that the preparation on the moving portion 10 side has been completed.

In a case where the notification of the preparation completion is received from each of the arm position control unit 341 and the movement following control unit 342, the playback control unit 340 starts the playback of the taught action. Specifically, the playback control unit 340 sequentially delivers the teaching data to the arm position control unit 341 and the movement following control unit 342 at the same timing as elapsed time at the time of teaching on the basis of elapsed time from the start of the playback (S204).

As a result, the arm position control unit 341 controls the position of the distal end of the arm portion 20 according to the delivered teaching data, and thus can reproduce the action at the time of teaching (S205). Note that, in a case where time intervals of the delivered teaching data are not constant, the arm position control unit 341 may perform linear interpolation between the current joint angle and a target joint angle and instruct the arm control unit 320 on the joint angle. Alternatively, in a case where information regarding an angular velocity and angular acceleration of each joint of the arm portion 20 is further stored at the time of teaching, the arm position control unit 341 may interpolate the trajectory of the arm portion 20 during the action with a 5th order polynomial using these pieces of information. Furthermore, in a case where an action of the end effector portion 25 is stored in the teaching data, the arm position control unit 341 may instruct the arm control unit 320 on the action of the end effector portion 25.

Note that, in a case where the teaching data of the arm portion 20 in the movement mode is omitted to reduce the volume of data, the arm position control unit 341 may instruct the arm control unit 320 to make the arm portion 20 still during the movement of the moving portion 10. In such a case, the playback control unit 340 may determine that there is an interval in the teaching data of the arm portion 20 and instruct the arm position control unit 341 to initialize the arm portion 20. According to this instruction, the arm position control unit 341 instructed to initialize the arm portion 20 operates the arm portion 20 from the current position to a position corresponding to the next data, similarly to the case where the first data is delivered, and then makes the arm portion 20 still on the spot until the subsequent teaching data is delivered.

The movement following control unit 342 controls the movement of the moving portion 10 according to the delivered teaching data on the basis of following control using Formulas 2 described above, and thus reproduces the taught action (S205).

Here, the playback control unit 340 determines whether or not the teaching data has been delivered to the arm position control unit 341 and the movement following control unit 342 to the end (S206). In a case where the teaching data has not been delivered to the end (S206/No), the playback control unit 340 continues to deliver the teaching data to the arm position control unit 341 and the movement following control unit 342, and operates the arm portion 20 and the moving portion 10 according to the teaching data.

In a case where the teaching data has been delivered to the end (S206/Yes), the playback control unit 340 notifies the user of the end of the playback. The user notified of the end of the playback gives an instruction to end the playback via the input unit 350. As a result, the overall control unit 360 ends the actions of the moving portion 10 and the arm portion 20 by ending the action of the playback control unit 340 (S207). As a result, the mobile body 1 can implement the playback of the taught action.

### 4. Specific Example

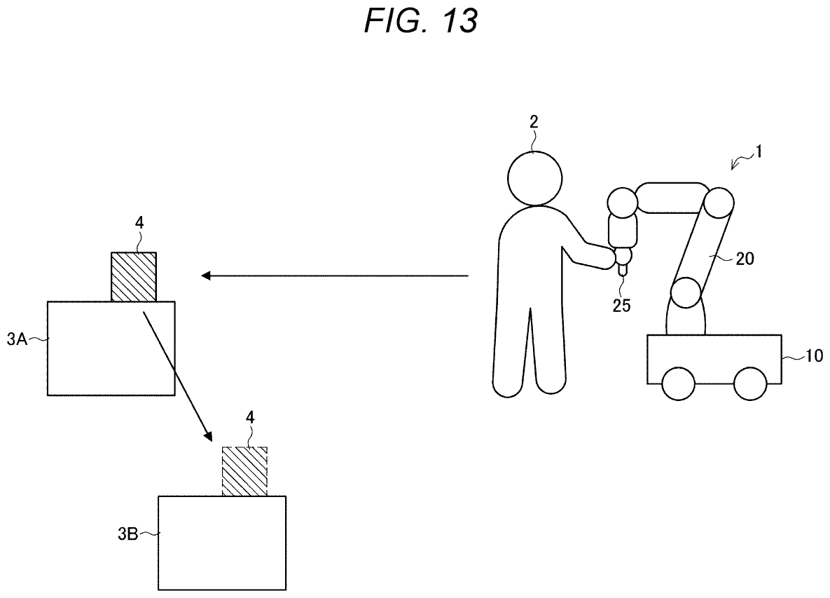

Moreover, a specific example of teaching and playback by a user will be described with reference to FIG. 13. FIG. 13 is a schematic diagram illustrating a specific example of teaching by a user 2 directly operating the mobile body 1.

### (Teaching)

As illustrated in FIG. 13, for example, in work of transporting an object 4 from a first stand 3A to a second stand 3B, the following tasks occur.
The mobile body 1 is brought close to the first stand 3A on which the object 4 is placed.
The object 4 is gripped by the end effector portion 25.
The mobile body 1 is brought close to the second stand 3B.
The object 4 is placed on the second stand 3B.

According to the technology according to the present disclosure, the user 2 teaches the mobile body 1 while switching between the movement mode for moving the moving portion 10 and the manipulation mode for operating the arm portion 20, and thus can perform the teaching more intuitively and smoothly.

In the case of teaching the mobile body 1, first, the user 2 performs an operation of starting teaching with the input unit 350. As a result, the mobile body 1 is set in the manipulation mode, and storing teaching data of the arm portion 20 and the moving portion 10 is started. Thereafter, the user 2 starts an operation of the mobile body 1 by applying a force to the distal end of the arm portion 20.

Subsequently, the user 2 teaches an action of moving the mobile body 1 to the first stand 3A in the movement mode. This is because the object 4 cannot be reached only by an action of the arm portion 20. For example, the user 2 pulls the arm portion 20 forward so as to approach the first stand 3A, causes the position of the distal end of the arm portion 20 to exceed the manipulation region, and thus can switch the control mode of the mobile body 1 to the movement mode.

By switching to the movement mode, the arm portion 20 is controlled to return to the position where the control mode has been switched by the virtual spring. As a result, the moving portion 10 starts to move on the basis of an operation by the user 2 on the arm portion 20. Therefore, the user 2 can move the mobile body 1 to a desired place by intuitively operating the arm portion 20 in a desired direction. Furthermore, the user 2 can intuitively adjust the moving velocity of the moving portion 10 by changing an external force applied to the arm portion 20. According to this operation, the user 2 can more easily confirm whether or not the arm portion 20 is likely to reach the object 4 and whether or not the work is possible while actually moving the mobile body 1.

Next, after moving the mobile body 1 to the first stand 3A on which the object 4 is placed, the user 2 teaches an action of gripping the object 4 with the arm portion 20 in the manipulation mode. For example, the user 2 lifts the arm portion 20 upward, causes the position of the distal end of the arm portion 20 to exceed the movement control range, and thus can switch the control mode of the mobile body 1 to the manipulation mode. Therefore, the user 2 can switch the control mode to the manipulation mode only by the operation of the arm portion 20 without unintentionally moving the moving portion 10.

By switching to the manipulation mode, the term of the virtual spring is invalidated, and the arm portion 20 is controlled so as to be freely operable with a light force. As a result, the user 2 operates the arm portion 20 to bring the distal end close to the object 4, so that the end effector portion 25 can grip the object 4. Note that, since the switching to the manipulation mode prevents the moving portion 10 from moving, the user 2 can focus on the operation of the arm portion 20 without worrying about the movement of the moving portion 10.

Subsequently, the user 2 teaches an action of moving the mobile body 1 to the second stand 3B in the movement mode. For example, the user 2 pulls the arm portion 20 forward so as to approach the second stand 3B, causes the position of the distal end of the arm portion 20 to exceed the manipulation region, and thus can switch the control mode of the mobile body 1 to the movement mode.

By switching to the movement mode, the arm portion 20 is controlled so as to return to the position where the control mode has been switched again by the virtual spring, and the moving portion 10 starts to move on the basis of the operation by the user 2 on the arm portion 20. Therefore, the user 2 can move the mobile body 1 to a desired place by intuitively operating the arm portion 20 in a desired direction.

Thereafter, the user 2 teaches an action of placing the object 4 gripped by the arm portion 20 on the second stand 3B in the manipulation mode. For example, the user 2 lifts the arm portion 20 upward, causes the position of the distal end of the arm portion 20 to exceed the movement control range, and thus can switch the control mode of the mobile body 1 to the manipulation mode. As a result, the user 2 operates the arm portion 20 to release the object 4 from the end effector portion 25, and thus can place the object 4 on the second stand 3B.

As described above, according to the technology according to the present disclosure, the user 2 can switch the control mode to the manipulation mode and the movement mode only by operating the arm portion 20. Therefore, the user 2 can perform the teaching to the mobile body 1 only by the operation of the arm portion 20.

### (Playback)

In a case of playing back the work taught above, first, the user 2 performs an operation of starting the playback with the input unit 350. As a result, the moving portion 10 moves to the position at the start of teaching, and at the same time, the arm portion 20 moves to the orientation at the start of teaching. After the moving portion 10 and the arm portion 20 reach the states at the start of teaching, the mobile body 1 starts playing back the taught action.

Subsequently, the mobile body 1 moves to the front of the first stand 3A on which the object 4 is placed in a state where the arm portion 20 extends forward, which corresponds to the operation of pulling the arm portion 20 toward the object 4 at the time of teaching. Next, after the mobile body 1 reaches the front of the first stand 3A, the mobile body 1 stops, and the action of gripping the object 4 by the arm portion 20 is started. As a result, the object 4 is gripped by the end effector portion 25 at the distal end of the arm portion 20.

Subsequently, after the arm portion 20 gripping the object 4 extends toward the second stand 3B, the mobile body 1 moves to the front of the second stand 3B. Furthermore, after the mobile body 1 reaches the front of the second stand 3B, the mobile body 1 stops and releases the object 4 from the end effector portion 25 at the distal end of the arm portion 20 to place the object 4 on the second stand 2B.

As described above, according to the technology according to the present disclosure, the mobile body 1 can reproduce work at the time of teaching on the basis of teaching data.

### 5. Modifications

### (First Modification)

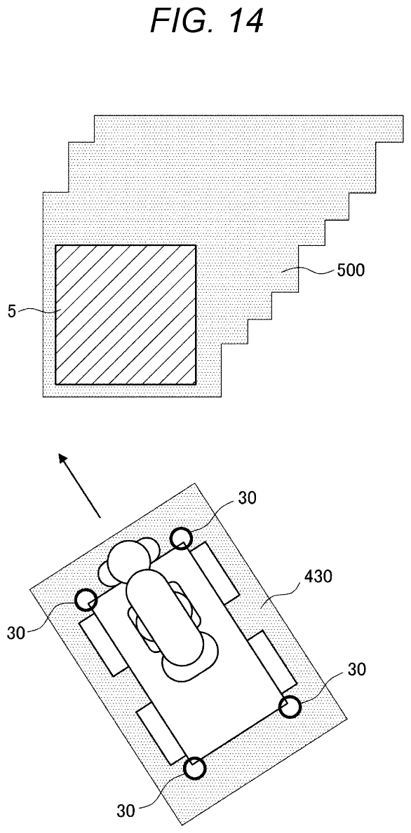

FIG. 14 is an explanatory diagram for describing a first modification of the mobile body 1. The mobile body 1 according to the first modification may further have a function of detecting an obstacle and a function of avoiding the detected obstacle as functions related to movement of the moving portion 10.

As illustrated in FIG. 14, the mobile body 1 according to the first modification includes a distance measurement sensor 30 such as LiDAR in the moving portion 10. According to this configuration, the control unit 300 uses distance measurement information from the distance measurement sensor 30 provided in the moving portion 10, and thus can generate an occupancy grid map indicating an obstacle region 500 occupied by an obstacle 5. Therefore, the control unit 300 can move the moving portion 10 along such a moving route as to avoid the obstacle region 500 indicated in the occupancy grid map.

Specifically, the movement control unit 311 can control the moving route of the moving portion 10 such that an occupied region 430 of the moving portion 10 based on the self-position estimated by the self-position estimation unit 312 does not interfere with the obstacle region 500. Furthermore, in a case where the distance between the occupied region 430 and the obstacle region 500 is within a threshold, the moving velocity calculation unit 333 may prevent the moving portion 10 from colliding with the obstacle 5 by overwriting vₓ derived by Formula 3 with 0. Furthermore, the moving velocity calculation unit 333 may gradually reduce vₓ derived by Formula 3 according to the distance between the occupied region 430 and the obstacle region 500, and thus may control the velocity of the mobile body 1 such that the mobile body 1 stops before the obstacle 5.

### (Second Modification)

The mobile body 1 according to the second modification may include a plurality of arm portions 20. The mobile body 1 according to the second modification provides force sensors at the distal ends of the plurality of arm portions 20, recognizes an external force detected by each of the force sensors as an operation on the mobile body 1, and thus can similarly perform teaching and playback.

Specifically, in a case where the plurality of arm portions 20 is present, the control mode of each of the arm portions 20 is controlled to either the manipulation mode or the movement mode independently of each other.

In a case where the arm portions 20 are set to the manipulation mode, each of the arm portions 20 set to the manipulation mode may act independently of each other on the basis of an operation by a user.

In a case where the arm portions 20 are set to the movement mode, the mobile body 1 may recognize the total of operations by the user applied to the arm portions 20 set to the movement mode as an operation on the moving portion 10. Specifically, the mobile body 1 may recognize a composite vector of estimated external forces applied to the plurality of arm portions 20 set to the movement mode or a composite vector of position deviations of the plurality of arm portions 20 set to the movement mode as an operation on the moving portion 10. According to this recognition, even in a case where the mobile body 1 includes the plurality of arm portions 20, the mobile body 1 can move the moving portion 10 on the basis of an operation by the user as in a case where the mobile body 1 includes one arm portion 20.

Furthermore, it is also conceivable that the arm portion 20 set to the movement mode and the arm portion 20 set to the manipulation mode are mixed, and each of the arm portions 20 is simultaneously operated by the user. In such a case, the mobile body 1 may move the moving portion 10 on the basis of an operation of the arm portion 20 set to the movement mode, and operate the corresponding arm portion 20 according to an operation on the arm portion 20 set to the manipulation mode. According to this operation, the user can smoothly teach even the mobile body 1 including the plurality of arm portions 20.

Although the preferred embodiment of the present disclosure has been described above in detail with reference to the accompanying drawings, the technical scope of the present disclosure is not limited to such an example. It is obvious that a person having ordinary knowledge in the technical field of the present disclosure can conceive various changes or modifications within the scope of the technical idea described in the claims, and it is naturally understood that these also fall within the technical scope of the present disclosure.

For example, in the above embodiment, the mobile body 1 performs the playback using the teaching data taught to the mobile body 1, but the present technology is not limited to such an example.

For example, in a case where the teaching data is data indicating a time-series transition of the position of the distal end of the arm portion 20 and the position and orientation of the moving portion 10, the mobile body 1 can reproduce the actions of the arm portion 20 and the moving portion 10 regardless of the configurations of the arm portion 20 and the moving portion 10. By importing the teaching data from the outside, the mobile body 1 can play back work taught to another mobile body having a different configuration. Furthermore, the mobile body 1 exports the teaching data taught to the mobile body 1 itself to the outside, and thus can cause another mobile body having a different configuration to play back work taught to the mobile body 1.

Furthermore, the effects described in the present specification are merely illustrative or exemplary, and are not restrictive. That is, the technology according to the present disclosure can exhibit other effects apparent to those skilled in the art from the description of the present specification, in addition to the effects described above or instead of the effects described above.

Note that the following configurations also fall within the technical scope of the present disclosure.

(1)

A control device including
a mode determination unit that determines a control mode of a mobile body including a moving mechanism and an articulated arm portion on the basis of a position of a distal end of the articulated arm portion of the mobile body,
in which
the moving mechanism and the articulated arm portion are controlled in a different manner for each control mode on the basis of the position of the distal end of the articulated arm portion or an external force applied to the distal end.
   (2)

The control device according to (1), in which the control mode includes a movement mode in which movement by the moving mechanism is controlled on the basis of the position of the distal end of the articulated arm portion or the external force applied to the distal end, and a manipulation mode in which an action of the articulated arm portion is controlled on the basis of the position of the distal end of the articulated arm portion or the external force applied to the distal end.

(3)

The control device according to (2), in which the mode determination unit determines the control mode as the movement mode in a case where the distal end of the articulated arm portion exceeds a manipulation range set three-dimensionally around a rear end opposite to the distal end of the articulated arm portion during the manipulation mode.

(4)

The control device according to (3), in which the manipulation range has a rotating body shape having a first joint shaft, which is first from a side of the rear end of the articulated arm portion, as a central axis.

(5)

The control device according to (4), in which the rotating body shape is a cylindrical shape or a hollow cylindrical shape having the first joint shaft as a central axis.

(6)

The control device according to (4), in which the manipulation range has a spherical shape centered on an intersection of the first joint shaft and a second joint shaft, which is second from the side of the rear end of the articulated arm portion.

(7)

The control device according to any one of (3) to (6), in which the mode determination unit determines the control mode as the manipulation mode in a case where the distal end of the articulated arm portion exceeds a movement control range set in a band-shaped space parallel to a traveling surface of the moving mechanism during the movement mode.

(8)

The control device according to (7), in which the movement control range is set on the basis of the position of the distal end of the articulated arm portion when the control mode is determined as the movement mode.

(9)

The control device according to (7) or (8), in which the mode determination unit determines the control mode as the movement mode in a case where the distal end of the articulated arm portion exceeds the manipulation range and the distal end of the articulated arm portion exceeds the movement control range.

(10)

The control device according to any one of (2) to (9), in which in the manipulation mode, the position of the distal end of the articulated arm portion is controlled on the basis of the external force applied to the distal end.

(11)

The control device according to (10), in which in the manipulation mode, the moving mechanism is controlled not to move.

(12)

The control device according to any one of (2) to (11), in which in the movement mode, a moving direction and a moving velocity of the moving mechanism are controlled on the basis of the position of the distal end of the articulated arm portion or the external force applied to the distal end.

(13)

The control device according to (12), in which in the movement mode, the articulated arm portion is controlled to return to an original position and orientation by a spring constant in response to the external force applied to the distal end of the articulated arm portion.

(14)

The control device according to (12) or (13), in which in the movement mode, the moving direction and the moving velocity of the moving mechanism are controlled such that the moving mechanism does not enter an entry disabled region set on the basis of an object around the mobile body.

(15)

The control device according to any one of (1) to (14), further including
a playback control unit that controls actions of the moving mechanism and the articulated arm portion of the mobile body on the basis of teaching data that is time-series data related to transition of a position of the mobile body and the position of the distal end of the articulated arm portion in a predetermined period.
   (16)

The control device according to (15), in which the playback control unit controls the actions of the moving mechanism and the articulated arm portion so as to reproduce, in time series, an action of the mobile body in the predetermined period.

(17)

A control method including
determining, by an arithmetic processing device, a control mode of a mobile body including a moving mechanism and an articulated arm portion on the basis of a position of a distal end of the articulated arm portion of the mobile body,
in which
the moving mechanism and the articulated arm portion are controlled in a different manner for each control mode on the basis of the position of the distal end of the articulated arm portion or an external force applied to the distal end.
   (18)

A program for causing a computer to function as
a mode determination unit that determines a control mode of a mobile body including a moving mechanism and an articulated arm portion on the basis of a position of a distal end of the articulated arm portion of the mobile body,
in which
the moving mechanism and the articulated arm portion are controlled in a different manner for each control mode on the basis of the position of the distal end of the articulated arm portion or an external force applied to the distal end.
   (19)

A mobile body including:
a moving mechanism;
an articulated arm portion attached to the moving mechanism; and
a mode determination unit that determines a control mode of the moving mechanism and the articulated arm portion on the basis of a position of a distal end of the articulated arm portion,
in which
the moving mechanism and the articulated arm portion are controlled in a different manner for each control mode on the basis of the position of the distal end of the articulated arm portion or an external force applied to the distal end.

### REFERENCE SIGNS LIST

1 Mobile body
10 Moving portion
20 Arm portion
25 End effector portion
300 Control unit
311 Movement control unit
312 Self-position estimation unit
320 Arm control unit
330 Teaching control unit
332 Impedance control unit
333 Moving velocity calculation unit
334 Arm data storage unit
335 Movement data storage unit
336 Teaching data storage unit
340 Playback control unit
341 Arm position control unit
342 Movement following control unit
350 Input unit
360 Overall control unit

1. A control device comprising
a mode determination unit that determines a control mode of a mobile body including a moving mechanism and an articulated arm portion on a basis of a position of a distal end of the articulated arm portion of the mobile body,
wherein
the moving mechanism and the articulated arm portion are controlled in a different manner for each control mode on a basis of the position of the distal end of the articulated arm portion or an external force applied to the distal end.

2. The control device according to claim 1, wherein the control mode includes a movement mode in which movement by the moving mechanism is controlled on a basis of the position of the distal end of the articulated arm portion or the external force applied to the distal end, and a manipulation mode in which an action of the articulated arm portion is controlled on a basis of the position of the distal end of the articulated arm portion or the external force applied to the distal end.

3. The control device according to claim 2, wherein the mode determination unit determines the control mode as the movement mode in a case where the distal end of the articulated arm portion exceeds a manipulation range set three-dimensionally around a rear end opposite to the distal end of the articulated arm portion during the manipulation mode.

4. The control device according to claim 3, wherein the manipulation range has a rotating body shape having a first joint shaft, which is first from a side of the rear end of the articulated arm portion, as a central axis.

5. The control device according to claim 4, wherein the rotating body shape is a cylindrical shape or a hollow cylindrical shape having the first joint shaft as a central axis.

6. The control device according to claim 4, wherein the manipulation range has a spherical shape centered on an intersection of the first joint shaft and a second joint shaft, which is second from the side of the rear end of the articulated arm portion.

7. The control device according to claim 3, wherein the mode determination unit determines the control mode as the manipulation mode in a case where the distal end of the articulated arm portion exceeds a movement control range set in a band-shaped space parallel to a traveling surface of the moving mechanism during the movement mode.

8. The control device according to claim 7, wherein the movement control range is set on a basis of the position of the distal end of the articulated arm portion when the control mode is determined as the movement mode.

9. The control device according to claim 7, wherein the mode determination unit determines the control mode as the movement mode in a case where the distal end of the articulated arm portion exceeds the manipulation range and the distal end of the articulated arm portion exceeds the movement control range.

10. The control device according to claim 2, wherein in the manipulation mode, the position of the distal end of the articulated arm portion is controlled on a basis of the external force applied to the distal end.

11. The control device according to claim 10, wherein in the manipulation mode, the moving mechanism is controlled not to move.

12. The control device according to claim 2, wherein in the movement mode, a moving direction and a moving velocity of the moving mechanism are controlled on a basis of the position of the distal end of the articulated arm portion or the external force applied to the distal end.

13. The control device according to claim 12, wherein in the movement mode, the articulated arm portion is controlled to return to an original position and orientation by a spring constant in response to the external force applied to the distal end of the articulated arm portion.

14. The control device according to claim 12, wherein in the movement mode, the moving direction and the moving velocity of the moving mechanism are controlled such that the moving mechanism does not enter an entry disabled region set on a basis of an object around the mobile body.

15. The control device according to claim 1, further comprising
a playback control unit that controls actions of the moving mechanism and the articulated arm portion of the mobile body on a basis of teaching data that is time-series data related to transition of a position of the mobile body and the position of the distal end of the articulated arm portion in a predetermined period.

16. The control device according to claim 15, wherein the playback control unit controls the actions of the moving mechanism and the articulated arm portion so as to reproduce, in time series, an action of the mobile body in the predetermined period.

17. A control method comprising
determining, by an arithmetic processing device, a control mode of a mobile body including a moving mechanism and an articulated arm portion on a basis of a position of a distal end of the articulated arm portion of the mobile body,
wherein
the moving mechanism and the articulated arm portion are controlled in a different manner for each control mode on a basis of the position of the distal end of the articulated arm portion or an external force applied to the distal end.

18. A program for causing a computer to function as
a mode determination unit that determines a control mode of a mobile body including a moving mechanism and an articulated arm portion on a basis of a position of a distal end of the articulated arm portion of the mobile body,
wherein
the moving mechanism and the articulated arm portion are controlled in a different manner for each control mode on a basis of the position of the distal end of the articulated arm portion or an external force applied to the distal end.

19. A mobile body comprising:
a moving mechanism;
an articulated arm portion attached to the moving mechanism; and
a mode determination unit that determines a control mode of the moving mechanism and the articulated arm portion on a basis of a position of a distal end of the articulated arm portion,
wherein
the moving mechanism and the articulated arm portion are controlled in a different manner for each control mode on a basis of the position of the distal end of the articulated arm portion or an external force applied to the distal end.
